(19) United States
(12) Patent Application Publication
(10) Pub. No.: US 2022/0413719 A1
(43) Pub. Date: Dec. 29, 2022

(54) MAINTAINING QUEUES FOR MEMORY SUB-SYSTEMS

(71) Applicant: Micron Technology, Inc., Boise, ID (US)

(72) Inventors: Jiangang Wu, Milpitas, CA (US); Jing Sang Liu, Shanghai (CN); James P. Crowley, Longmont, CO (US); Yun Li, Fremont, CA (US)

(21) Appl. No.: 16/954,272

(22) PCT Filed: Mar. 10, 2020
(86) PCT No.: PCT/CN2020/078605

§ 371 Date: Jun. 16, 2020

(51) Int. Cl. G06F 3/06

(52) U.S. Cl. CPC G06F 3/0625; G06F 3/0679; G06F 3/0659

(57) ABSTRACT

Methods, systems, and devices for data stream processing for maintaining queues for memory sub-systems are described. A number of commands included in a queue of a plurality of queues of a memory die of a memory sub-system can be determined. Each queue can be associated with a respective priority level and can be configured to maintain a respective set of commands. A command can be assigned to the queue based on a number of commands included in the queue. One or more commands can be issued from the queues based on the respective priority levels of the queues.

### CROSS REFERENCE

The present Application for Patent is a 371 national phase filing of International Patent Application No. PCT/CN2020/078605 by Wu et al., entitled “MAINTAINING QUEUES FOR MEMORY SUB-SYSTEMS,” filed Mar. 10, 2020, assigned to the assignee hereof, and expressly incorporated by reference herein.

### TECHNICAL FIELD

The following relates generally to a memory sub-system and more specifically to maintaining queues for memory sub-systems.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various examples of the disclosure. The drawings, however, should not be taken to limit the disclosure to the specific examples, but are for explanation and understanding only.

FIG. 1 illustrates an example computing system that includes a memory sub-system in accordance with some examples of the present disclosure.

FIG. 2 is a flow diagram of an example method to maintain queues for memory sub-systems in accordance with some examples of the present disclosure.

FIG. 3A example of a firmware queue of a memory sub-system in accordance with some examples of the present disclosure.

FIG. 3B is an example of a global pool for a memory controller in accordance with some examples of the present disclosure.

FIG. 4 is an example of a memory sub-system for maintaining queues in accordance with some examples of the present disclosure.

FIG. 5 is a block diagram of an example computer system in which examples of the present disclosure can operate.

### DETAILED DESCRIPTION

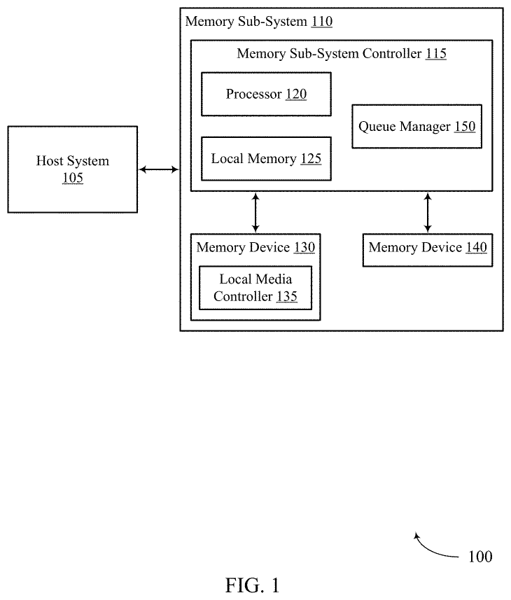

Aspects of the present disclosure are directed to maintaining queues of a memory sub-system. A memory sub-system can be a storage device, a memory module, or a hybrid of a storage device and memory module. Examples of storage devices and memory modules are described herein in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory device can be a non-volatile memory device. One example of non-volatile memory devices is a negative-and (NAND) memory device. Other examples of non-volatile memory devices are described below in conjunction with FIG. 1. A non-volatile memory device is a package of one or more dice. Each die can consist of one or more planes. Planes can be groups into logic units (LUN). For some types of non-volatile memory devices (e.g., NAND devices), each plane consists of a set of physical blocks. Each block consists of a set of pages. Each page consists of a set of memory cells (“cells”). A cell is an electronic circuit that stores information. A data block hereinafter refers to a unit of the memory device used to store data and can include a group of memory cells, a word line group, a word line, or individual memory cells.

Data operations can be performed by the memory sub-system. The data operations can be host-initiated operations. For example, the host system can initiate a data operation (e.g., write, read, erase, etc.) on a memory sub-system. The host system can send access requests (e.g., write command, read command) to the memory sub-system, such as to store data on a memory device at the memory sub-system and to read data from the memory device on the memory sub-system.

In traditional access operations of NAND cells, commands can be constantly transmitted to various memory dies. The commands can be associated with different access operations (e.g., read operations, write operations, etc.) having varying levels of priority. That is, it can be desirable for a host read command to be transmitted to a particular memory die before a read command or write command is transmitted to the same die. However, because memory sub-systems include many dies, and each die can be associated with a multitude commands and command types, traditional access operations can be unable to effectively prioritize transmitting commands. Additionally, because traditional access operations can be unable to effectively prioritize transmitting commands, lower-priority commands may be issued before higher-priority commands, which may undesirably utilize system resources (e.g., power). Accordingly, traditional access operations can result in system resources being allocated to relatively low priority operations, which prevents the memory sub-system from being able to issue higher-priority commands when necessary.

Aspects of the present disclosure address the above and other deficiencies by maintaining queues of a memory sub-system at a die level. For example, each memory die of a memory sub-system can be associated with a queue (e.g., a memory die queue) for maintaining commands associated with the respective die. Further, each memory die queue can include multiple sub-queues (e.g., priority queues) for maintaining commands associated with particular priority levels. Commands may be issued based on a priority level associated with a respective priority queue and also based on an amount of commands in the respective queue. That is, when a number of commands in a queue exceeds a threshold value, the commands may be issued before any additional commands are assigned to the queue. Thus commands may be issued based on both the priority level associated with the command and a number of commands in the queue. In some examples, the commands can be issued by a local memory controller.

For example, a memory die queue associated with a particular memory die of a memory sub-system can include one or more (e.g., two, three, six) priority queues. Each priority queue can be associated with (e.g., reserved for) commands associated with a particular priority level. When three priority queues are used, for instance, a first priority queue can be associated with commands having a first (e.g., a highest; a most-urgent) priority level, a second priority queue can be associated with commands having a second (e.g., an intermediate; a middle) priority level, and a third priority queue can be associated with commands having a third (e.g., a lowest; a least-urgent) priority level. When a command for the memory die is received, it can be assigned to a priority queue based on its associated priority level, which can be predefined. Accordingly, commands in a higher priority queue can be issued before commands in a lower priority queue—i.e., a command in the first priority queue can be issued before a command in the second priority queue. When higher priority commands are being issued, commands can still be assigned to lower-priority queues. However, when a quantity of commands in a queue exceeds a threshold value, the commands in the (e.g., all commands in the queue) can be issued regardless of the priority level associated with the queue. Once the commands are issued, the issuance of the commands in the other (e.g., higher-priority) queues can resume. Such techniques can be performed on a die-by-die or system level, both of which can alleviate system resources (e.g., power) needed to otherwise issue a large quantity of commands in a single queue.

FIG. 1 illustrates an example of a computing system 100 that includes memory sub-system 110 in accordance with some embodiments of the present disclosure. The memory sub-system 110 can include media, such as one or more non-volatile memory devices (e.g., memory device 130), one or more volatile memory devices (e.g., memory device 140), or a combination thereof.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile DIMM (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 105 that is coupled with one or more memory systems 110. In some examples, the host system 105 is coupled with different types of memory systems 110. FIG. 1 illustrates one example of a host system 105 coupled with one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 105 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 105 uses the memory sub-system 110, for example, to write data to the memory sub-system 110 and read data from the memory sub-system 110.

The host system 105 can be coupled to the memory sub-system 110 using a physical host interface. Examples of a physical host interface include, but are not limited to, a serial advanced technology attachment (SATA) interface, a peripheral component interconnect express (PCIe) interface, USB interface, Fiber Channel, Small Computer System Interface (SCSI), Serial Attached SCSI (SAS), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 105 and the memory sub-system 110. The host system 105 can further utilize an non-volatile memory Express (NVMe) interface to access components (e.g., memory devices 130) when the memory sub-system 110 is coupled with the host system 105 by the PCIe interface. The physical host interface can provide an interface for passing control, address, data, and other signals between the memory sub-system 110 and the host system 105. FIG. 1 illustrates a memory sub-system 110 as an example. In general, the host system 105 can access multiple memory sub-systems via a same communication connection, multiple separate communication connections, and/or a combination of communication connections.

The memory devices 130,140 can include any combination of the different types of non-volatile memory devices and/or volatile memory devices. The volatile memory devices (e.g., memory device 140) can be, but are not limited to, random access memory (RAM), such as dynamic RAM (DRAM) and synchronous DRAM (SDRAM).

Some examples of non-volatile memory devices (e.g., memory device 130) include negative-and (NAND) type flash memory and write-in-place memory, such as three-dimensional cross-point (“3D cross-point”) memory, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as NAND type flash memory (e.g., 2D NAND, 3D NAND) and 3D cross-point array of non-volatile memory cells are described, the memory device 130 can be based on any other type of non-volatile memory, such as ROM, phase change memory (PCM), self-selecting memory, other chalcogenide based memories, ferroelectric transistor random-access memory (FeTRANI), ferroelectric RANI (FeRANI), magneto RAM (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable ROM (EEPROM).

The memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The memory sub-system controller 115 can be a microcontroller, special purpose logic circuitry (e.g., a field programmable gate array (FPGA), an application specific integrated circuit (ASIC), digital signal processor (DSP)), or another suitable processor.

The memory sub-system controller 115 can include a processor 120 (e.g., a processing device) configured to execute instructions stored in a local memory 125. In the illustrated example, the local memory 125 of the memory sub-system controller 115 includes an embedded memory configured to store instructions for performing various processes, operations, logic flows, and routines that control operation of the memory sub-system 110, including handling communications between the memory sub-system 110 and the host system 105.

In some examples, the local memory 125 can include memory registers storing memory pointers, fetched data, etc. The local memory 125 can also include ROM for storing micro-code. While the example memory sub-system 110 in FIG. 1 has been illustrated as including the memory sub-system controller 115, in another example of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 105 and can convert the commands or operations into instructions or appropriate commands to achieve the desired access to the memory devices 130 and/or the memory device 140. The memory sub-system controller 115 can be responsible for other operations such as wear leveling operations, garbage collection procedures, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 105 via the physical host interface. The host interface circuitry can convert the commands received from the host system into command instructions to access the memory devices 130 and/or the memory device 140 as well as convert responses associated with the memory devices 130 and/or the memory device 140 into information for the host system 105.

The memory sub-system 110 can also include additional circuitry or components that are not illustrated. In some examples, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some examples, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory sub-system 110 includes a queue manager 150 that manages commands according to an associated priority level and number of commands associated with a particular queue. For example, each memory die (e.g., memory device 130, memory device 140) of a memory sub-system 110 can be associated with a memory die queue. The memory die queues can each include one or more priority queues where commands (e.g., read commands, write commands, host read commands, etc.) are allocated for issuance. When a command associated with a particular die is received, the queue manager 150 can determine a priority level associated with the command (i.e., the queue manager 150 can determine a type of the command) and allocate the command to a priority queue associated with the die. Commands may be issued from respective priority queues based on the associated priority levels. Thus commands associated with queues having a higher priority level can be issued before commands associated with queues having relatively lower priority levels. In some instances, however, lower-priority commands can accumulate in a respective queue while higher-priority commands are being issued. The queue manager 150 can manage (e.g., track) an amount of commands included in any one queue, and can issue the commands (e.g., all of the commands in the queue) if the quantity exceeds a threshold value. Once the commands are issued, the queue manager 150 can resume issuing commands based on their associated priority levels.

The quantity of commands in any one queue can be managed on a die-by-die level (e.g., a number of commands in priority queues associated with a single die) or globally (e.g., based on a number of active dies of the sub-system). In either example, preventing queues from amassing an threshold quantity of commands can alleviate system resources (e.g., power) that can be otherwise utilized for issuing the commands in the queue.

In some examples, the memory sub-system controller 115 includes at least a portion of the queue manager 150. For example, the memory sub-system controller 115 can include a processor 120 (e.g., a processing device) configured to execute instructions stored in local memory 125 for performing the operations described herein. In some examples, the queue manager 150 is part of the host system 105, an application, or an operating system.

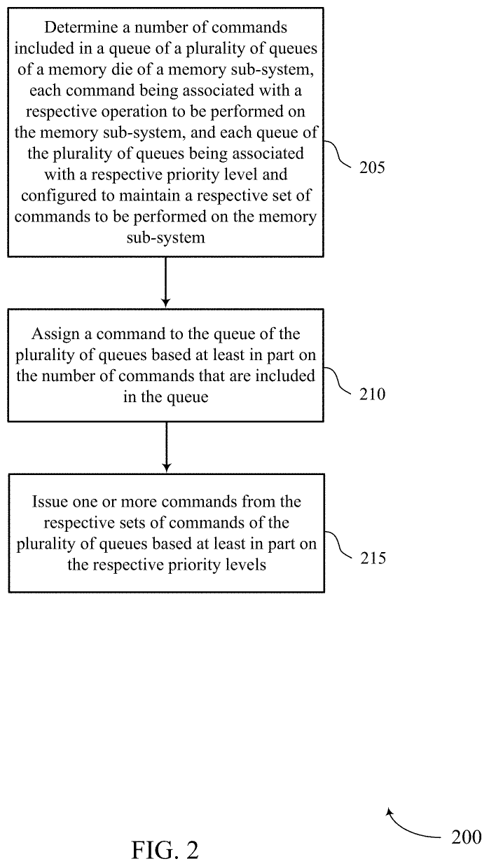

FIG. 2 is a flow diagram of an example method 200 for maintaining queues for memory sub-systems in accordance with some examples of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some examples, the method 200 is performed by the queue manager 150 of FIG. 1. Although shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other method flows are possible.

At operation 205, the processing device can determine a number of commands included in a plurality of queues of a memory die of a memory sub-system. Each command can be associated with a respective operation to be performed on the memory sub-system and each queue of the plurality of queues can be associated with a respective priority level and be configured to maintain a respective set of commands to be performed on the memory sub-system.

At operation 210, the processing device can assign a command to the queue of the plurality of queues based at least in part on the number of commands that are included in the queue.

At operation 215, the processing device can issue one or more commands from the respective sets of commands of the plurality of queues based at least in part on the respective priority levels.

In some examples, the method 200 can include prohibiting each of the plurality of queues that have a number of commands that exceeds a threshold value from accepting additional commands until the number of commands is below the threshold value.

In some examples, the method 200 can include assigning one or more additional commands to each queue having a respective number of commands below the threshold value and issuing the one or more additional commands from each queue based at least in part on the respective priority levels.

In some examples, the method 200 can include issuing all of the commands for each queue having the number of commands that exceed the threshold value. Assigning one or more additional commands to each queue can be based at least in part on issuing all of the commands.

In some examples, the method 200 can include storing, to a memory of the memory sub-system, at least one command associated with a queue having a respective number of commands that exceeds the threshold value and assigning the command to the queue based at least in part on the respective number of commands falling below the threshold value.

In some examples of the method 200, the threshold value is based at least in part on resources of the memory sub-system available for performing operations on the memory sub-system.

In some examples, the method 200 can include assigning, to a set of queues for a plurality of memory dies of the memory sub-system, one or more commands associated with operations to be performed on the memory sub-system and issuing commands from the set of queues according to the respective priority levels. Each queue of the set of queues can be associated with a respective priority level.

In some examples, the method 200 can include determining a number of active memory dies of the memory sub-system and prohibiting one or more active memory dies of the memory sub-system from accepting additional commands when the number of active memory dies exceeds a threshold value.

In some examples, the method 200 can include determining that a plurality of active memory dies of the memory sub-system exceed the threshold value. Prohibiting the one or more active memory dies from accepting additional commands ban be based at least in part on a number of commands associated with each of the one or more active memory dies.

In some examples of the method 200, the one or more commands for performing an operation on the memory die includes a read command, a write command, a host read command, a host write command, or a combination thereof.

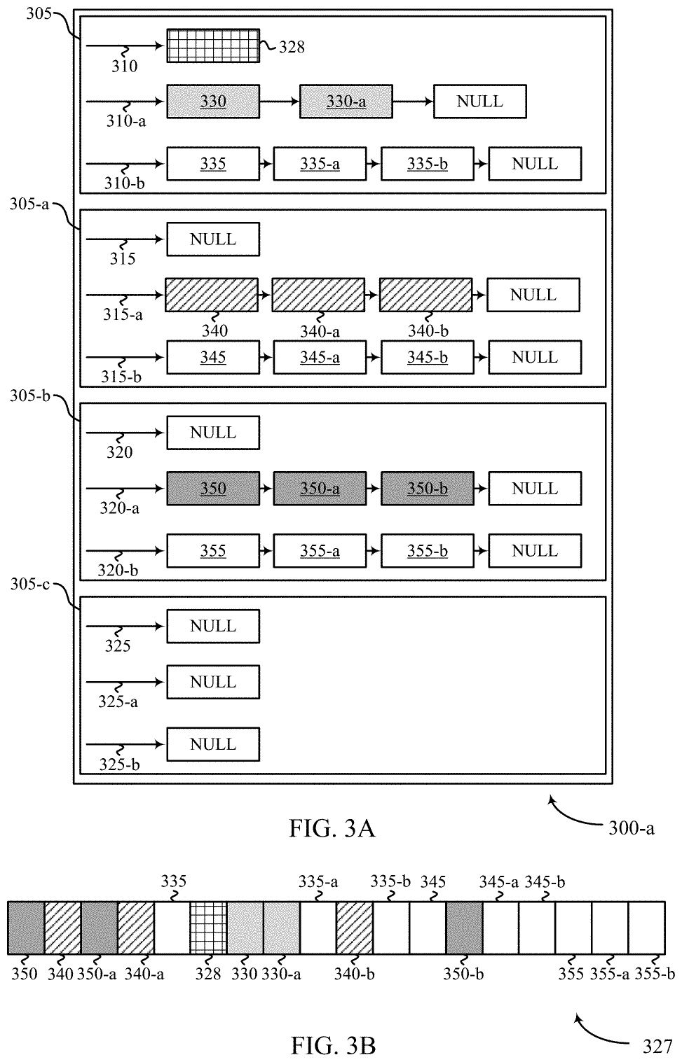

FIG. 3A illustrates an example of a firmware queue 300-a that supports maintaining queues of a memory sub-system in accordance with some examples of the present disclosure. The firmware queue 300-a illustrates a plurality of memory die queues 305 (e.g., LUN queues 305) that each include one or more priority queues. For example, a first memory die queue 305 can include priority queues 310, 310-a, and 310-b. In some examples, priority queue 310 can correspond to a first priority queue, priority queue 310-a can correspond to a second priority queue, and priority queue 310-b can correspond to a third priority queue. The priority queues 310 can include particular commands (e.g., requests to complete commands), and the commands can be issued by a local memory controller (e.g., a flash memory controller). In some examples, the local memory controller can issue the commands according the priority level of the respective queue 310 or based on a quantity of commands in any one particular queue exceeding a threshold value. In some examples, commands can be assigned to a queue 310 on-the-fly, which may result in the issuance of other commands (associated with different priority levels) being temporarily suspended. By preventing particular queues from including a quantity of commands in excess of a threshold value, the system can preserve resources that would otherwise be incurred due to an even larger quantity of commands being included in the respective queue.

As discussed herein, the memory die queue 305 can include priority queues 310, 310-a, and 310-b, which may correspond to a first priority queue, a second priority queue, and a third priority queue, respectively. In some examples, the first priority queue 310 can be assigned a highest priority level (e.g., relative to the second and third priority queues). By assigning the priority queue 310 a highest priority level, any command pertaining to the associated memory die that is placed in the priority queue 310 can be issued (e.g., sent to a local memory controller) before commands in the priority queues 310-a and 310-b. Similarly, the second priority queue 310-a can be assigned an intermediate priority level (e.g., relative to the first and third priority queues). By assigning the priority queue 310-a an intermediate priority level, any command pertaining to the associated memory die that is placed in the priority queue 310-a can be issued before commands in the priority queue 310-b. In other examples, the third priority queue 310-b can be assigned a lowest priority level (e.g., relative to the first and second priority queues). By assigning the priority queue 310-b a lowest priority level, any command pertaining to the associated memory die that is placed in the priority queue 310-b can be issued only when priority queues 310 and 310-a are empty (e.g., they do not contain any commands).

Additionally or alternatively, each priority queue of the memory die queue 305 can be associated with a threshold value. That is, if a number of commands in the particular priority queue exceeds the threshold value, the system can issue one or more (or all) of the commands in that queue in order to alleviate system resources. Without implementing a threshold value for issuing commands from a priority queue, the queue could continue to receive commands to be issued. Accordingly, the system can save resources by not being forced to issue the commands that would otherwise have been accumulated in the particular queue. As discussed herein, the threshold value can be assigned per-memory-die-queue or per-priority-queue. For example, if the threshold value was assigned per-memory-die-queue, the first priority queue 310, the second priority queue 310-a, and the third priority queue 310-b of the memory die queue 305 could all be associated with a same threshold value. Conversely, if the threshold value was assigned per-priority-queue, the first priority queue 310, the second priority queue 310-a, and the third priority queue 310-b of the memory die queue 305 could all be associated with a different threshold value.

By way of example, the first memory die queue 305 can include command 328 in the priority queue 310 and commands 330 and 330-a in the priority queue 310-a. The first memory die queue 305 can also include commands 335, 335-a, and 335-b in the priority queue 310-b. In some examples, each of the commands in the priority queues 310, 310-a, and 310-b can be different commands that are received at different times. That is, commands can be entered into the priority queues 310, 310-a, and 310-b as they are issued. Accordingly, because the priority queue 310 can be associated with a higher priority level than the priority queues 310-a and 310-b, the command 328 can be issued before the commands 330, 330-a, 335, 335-a, and 335-b.

However, the third priority queue 310-b can be associated with a threshold value that could allow for the commands 335, 335-a, and 335-b to be issued before one or more of the commands 328, 330, and 330-a. For example, the threshold value (in either a per-memory-die-queue or a per-priority-queue configuration) for the third priority queue 310-b can be two commands. Because the commands 335, 335-a, and 335-b can be in the third priority queue 310-b at a same time (and at a same time that one or more of the commands 328, 330, and/or 330-a are included in a respective priority queue), the threshold value can be exceeded. Accordingly, in some examples, each of the commands 335, 335-a, and 335-b can be issued (e.g., at once, consecutively, etc.) before any of the other commands of the memory die queue 305 are issued.

Further, when it is determined that the quantity of commands in the third priority queue 310-b exceeds the threshold value, the third priority queue 310-b can be temporarily prevented from receiving any additional commands (i.e., the third priority queue 310-b can be “mucked”). During this time (e.g., until a quantity of commands is issued to reduce the quantity of commands below the threshold value), any additional command to be assigned to the third priority queue 310-b can be temporarily assigned to memory of the memory sub-system. Once the quantity of commands falls below the threshold value, the command(s) temporarily assigned to the memory of the memory sub-system can be moved (e.g., transferred) to the respective priority queue.

In some examples, the second memory die queue 305-a can include commands 340, 340-a, and 340-b in the priority queue 315-a. The second memory die queue 305-a can also include commands 345, 345-a, and 345-b in the priority queue 315-b. As shown in FIG. 3A the priority queue 315 can be temporarily empty (e.g., NULL), but can receive one or more commands (e.g., at a subsequent time; at a different time than shown). In some examples, each of the commands in the priority queues 315-a and 315-b can be different commands that are received at different times. That is, commands can be entered into the priority queues 315-a and 315-b as they are issued. In some examples, the commands can be entered at a same or different time than the commands entered into the priority queues 310-a and 310-b of the first memory die queue 305. Because the priority queue 315-a can be associated with a higher priority level than the priority queue 315-b, the commands 340, 340-a, and 340-b can be issued before the commands 345, 345-a, and 345-b.

As discussed above with respect to the memory die queue 305, each priority queue of the memory die queue 305-a can be associated with a threshold value. That is, if a number of commands in the particular priority queue exceeds the threshold value, the system can issue one or more (or all) of the commands in that queue in order to alleviate system resources. As discussed herein, the threshold value can be assigned per-memory-die-queue or per-priority-queue. For example, if the threshold value was assigned per-memory-die-queue, the first priority queue 315, the second priority queue 315-a, and the third priority queue 315-b of the memory die queue 305-a could all be associated with a same threshold value. This threshold value could be a same or different threshold value than the priority queues of, for example, memory die queue 305-a. Conversely, if the threshold value was assigned per-priority-queue, the first priority queue 315, the second priority queue 315-a, and the third priority queue 315-b of the memory die queue 305-a could all be associated with a different threshold value. Like the per-memory-die-queue threshold value, this threshold value could be a same or different threshold value than the priority queues of, for example, memory die queue 305-a.

By way of example, the second memory die queue 305-a can include commands 340, 340-a, and 340-b in the second priority queue 315-a and commands 345, 345-a, and 345-b in the second priority queue 315-b. In some examples, each of the commands in the priority queues 315-a and 315-b can be different commands that are received at different times. That is, commands can be entered into the priority queues 315-a and 315-b as they are issued. Accordingly, because the priority queue 310-a can be associated with a higher priority level than the priority queue 315-b, the commands 340, 340-a, and 340-b can be issued before the commands 345, 345-a, and 345-b.

However, the third priority queue 315-b can be associated with a threshold value that could allow for the commands 345, 345-a, and 345-b to be issued before one or more of the commands 340, 340-a, and 340-b. For example, the threshold value (in either a per-memory-die-queue or a per-priority-queue configuration) for the third priority queue 315-b can be one command. Because the commands 345, 345-a, and 345-b can be in the third priority queue 315-b at a same time (and at a same time that one or more of the commands 340, 340-a, and 340-b are included in the second priority queue 315-a), the threshold value can be exceeded. Accordingly, in some examples, each of the commands 345, 345-a, and 345-b can be issued (e.g., at once, consecutively, etc.) before any of the other commands of the memory die queue 305-a are issued.

Further, when it is determined that the quantity of commands in the third priority queue 315-b exceeds the threshold value, the third priority queue 315-b can be temporarily prevented from receiving any additional commands (i.e., the third priority queue 315-b can be “mucked”). During this time (e.g., until a quantity of commands is issued to reduce the quantity of commands below the threshold value), any additional command to be assigned to the third priority queue 315-b can be temporarily assigned to memory of the memory sub-system (e.g., local memory 125 of memory sub-system 110 in FIG. 1). Once the quantity of commands falls below the threshold value, the command(s) temporarily assigned to the memory of the memory sub-system can be moved (e.g., transferred) to the respective priority queue.

In some examples, the firmware queue 300-a can also include a third memory die queue 305-b and a fourth memory die queue 305-c. The fourth memory die queue 305 can also be or represent an nth memory die queue of the firmware queue 300-a. That is, the firmware queue 300-a can include a plurality of memory die queues that correspond to the memory dies of the memory sub-system. In some examples, the third memory die queue 305-b and fourth memory die queue 305-b can each include one or more priority queues for commands. For example, the third memory die queue 305-b can include commands 350, 350-a, and 350-b in the priority queue 320-a and commands 355, 355-a, and 355-b in the priority queue 320-b. As shown in FIG. 3A, the priority queues of the fourth memory die queue 305-c can be temporarily empty (e.g., NULL), but can receive one or more commands (e.g., at later time; at a different time).

As discussed with reference to memory die queues 305 and 305-a, the memory die queues 305-b and 305-c can issue commands according to the priority levels associated with the respective priority queues and based on a quantity of commands in any particular priority queue exceeding a threshold value. For example, commands 350, 350-a, and 350-b can be issued before commands 355, 355-a, and 355-b due to the priority level associated with the priority queue 320-a and/or due to the quantity of commands in the priority queue 320-a exceeding a threshold value. In other examples, and as discussed herein, issuance of the commands 350, 350-a, and 350-b may be temporarily suspended (e.g., mucked) when a quantity of commands in the priority queue 320-b exceeds a threshold value. Additionally or alternatively, threshold values associated with the third memory die queue 305-b and/or the fourth memory die queue 305-c can be set based on an amount of available system resources (e.g., an amount of power available to the memory sub-system) and can be set on either a per-memory-die-queue or a per-priority-queue basis.

In other examples, the threshold value can be based on a number of active memory dies of the memory sub-system. For example, if the memory sub-system includes a number of active memory dies that exceeds the threshold value, one or more memory dies can be prohibited from receiving a command (regardless of its priority level) until the number of active memory dies falls below the threshold value. An active memory die can refer to any memory die that includes at least one command in a particular queue (e.g., a particular priority queue) and/or a memory die undergoing an access operation. For example, a threshold value of active memory dies can be ten (10) memory dies. When an eleventh (11th) memory die becomes active, at least one of the eleven (11) memory dies can be prohibited from receiving any additional commands until at least one memory die reverts to inactive status (e.g., it is no longer subject to an access operation and/or it no longer includes any commands in its priority queues). If a command is to be sent to a memory die that is temporarily prevented from receiving commands, the command can be temporarily assigned to memory of the memory sub-system. Once the quantity of active memory dies falls below the threshold value, the command(s) temporarily assigned to the memory of the memory sub-system can be moved (e.g., transferred) to a queue of the respective memory die.

In some examples, particular commands can be associated with predefined priority levels. For example, a first priority level (e.g., a highest priority level) can be associated with a host read command. That is, each time a host read associated with a particular memory die is issued, it can be assigned to the first priority queue of the memory die queue associated with the particular die. In other examples, a first priority level (e.g., an intermediate priority level) can be associated with a host write command, a read command, a write command, an erase command, or a combination thereof. All other types of commands can be associated with a third (or lower) priority level.

FIG. 3B illustrates an example of a global pool 327 in accordance with some examples of the present disclosure. The global pool 327 may include one or more commands from the priority queues discussed with reference to FIG. 3A. That is, requests to complete commands may be issued (e.g., released) from the priority queues to the global pool, and a local memory controller may issue an associated command based on the order in which they are entered into the pool. One or more of the commands can be issued based on a quantity of commands in an associated priority queue exceeding a threshold value. By preventing particular queues from including a quantity of commands in excess of a threshold value, the system can preserve resources that would otherwise be incurred due to an even larger quantity of commands being included in the respective queue.

In some examples, the global pool 327 can include each of the commands discussed with reference to FIG. 3A. The commands can be entered into (e.g., included in) the global pool 327 based on an order received (e.g., by the respective memory die queue 305), a respective priority level associated with the command, due to a quantity of commands in a particular queue exceeding a threshold value, or a combination thereof. In some examples, the commands in the global pool 327 can correspond to one or more resources (e.g., a memory address) associated with the command. That is, the commands in the global pool 327 can be issued by a local memory controller to access a particular memory cell or group of memory cells.

The global pool 327 can include commands from each of the memory die queues 305 discussed with reference to FIG. 3A. For example, commands 328, 330, 303-a, 335, 335-a, and 335-b from the first memory die queue 305 can be included in the global pool 327. Additionally or alternatively, commands 340, 340-a, 340-b, 345, 345-a, and 345-b from the second memory die queue 305-a can be included, as well as commands 350, 350-a, 350-b, 355, 355-a, and 355-b from the second memory die queue 305-b. The commands can be entered into the global pool 327 based on an order received at the respective memory die queue 305, based on a respective priority level associated with the command, due to a quantity of commands in a particular queue exceeding a threshold value, or a combination thereof.

In some examples, command 330 from the second priority queue 310-a of the first memory die queue 305 can be the first command in the global pool 327. The command 330 can be the first command entered into the global pool 327 due to it being received before any commands associated with a higher priority (e.g., command 328). In some examples, the command 330 can be entered into the global pool 327 before other commands associated with a same priority level (e.g., commands 330-a, 340, 340-a, 340-b, 350, 350-a, and/or 350-b) due to the command 330 being received first. Stated another way, the second priority queue 310-a can receive and the command 330 before any other memory die queues receive and issue a command with a same (or higher) priority level.

In some examples, command 340 from the second priority queue 315-a of the second memory die queue 305-a can be the next (e.g., the second) command in the global pool 327. The command 340 can be entered into the global pool 327 based on it being received after the command 330 but before any commands associated with a higher priority (e.g., command 328). In some examples, the command 340 can be entered into the global pool 327 before other commands associated with a same priority level (e.g., commands 330-a, 340, 340-a, 340-b, 350, 350-a, and/or 350-b) due to the command 340 being received first.

In some examples, command 330-a from the second priority queue 310-a of the first memory die queue 305 can be the next command in the global pool 327. The command 330-a can be entered into the global pool 327 based on it being received after the command 340 but before any commands associated with a higher priority (e.g., command 328). In some examples, the command 330-a can be entered into the global pool 327 before other commands associated with a same priority level (e.g., commands 340-a, 340-b, 350, 350-a, and/or 350-b) due to the command 330-a being received first.

In some examples, command 340-a from the second priority queue 315-a of the second memory die queue 305-a can be the next command in the global pool 327. The command 340-a can be entered into the global pool 327 based on it being received after the command 350-a but before any commands associated with a higher priority (e.g., command 328). In some examples, the command 340-a can be entered into the global pool 327 before other commands associated with a same priority level (e.g., commands 340-a, 340-b, 350, 350-a, and/or 350-b) due to the command 340-a being received first.

In some examples, command 335 from the third priority queue 310-b of the first memory die queue 305 can be the next command in the global pool 327. The command 335 can be entered into the global pool based on it being received when no other memory die queues include higher-priority commands. In some examples, the command 335 can be entered into the global pool 327 before other commands associated with a same priority level (e.g., commands 335-a, 335-b, 345, 345-a, 345-b, 355, 355-a, and/or 355-b) due to the command 335 being received first.

In some examples, command 328 from the first priority queue 310 of the first memory die queue 305 can be the next command in the global pool 327. The command 328 can be entered into the global pool 327 based on its priority alone. For example, because the command 328 is associated with a first (e.g., a highest priority), it can be entered into the global pool 327 even if other memory die queues include commands in respective priority queues. For example, the first memory die queue 305 can include commands 330 and 330-a in the second priority queue 310-a. However, due to the priority of the command 328, the command 328 may be issued first (e.g., before commands 330 and 330-a).

In some examples, at this point, the quantity of commands in the second priority queue 320-a of the memory die queue 305-b can exceed a threshold value. For example, the threshold value can be two (2) commands and each of commands 350, 350-a, and 350-b can be in the priority queue 320-a. Accordingly, despite any other higher-priority commands being in any other priority queues of the memory sub-system, the commands 350, 350-a, and 350-b can be issued. Until the commands are issued, the second priority queue 320-a of the memory die queue 305-b can be prevented from receiving any additional commands. That is, any command to be included in the priority queue 320-a can be temporarily stored to memory of the memory sub-system until the commands 350, 350-a, and 350-b are issued. Once the commands are issued and the number of commands in the priority queue 320-a falls below the threshold value, the priority queue 320-a can resume receiving command and other commands in the global pool 327 can be issued. By preventing particular queues from including a quantity of commands in excess of a threshold value, the system can preserve resources that would otherwise be incurred due to an even larger quantity of commands being included in the respective queue.

In some examples, each of the remaining commands (e.g., commands 340-b, 335-b, 345, 335-a, 345-a, 345-b, 355, 355-a, and 355-b) can be entered into the global pool 327 last. In some examples, the commands can be entered based on an order received, based on a priority level associated with a respective memory die queue of each command, or based on a quantity of commands of an associated priority queue exceeding a threshold value. As discussed herein, each command in the global pool 327 can be issued by a local memory controller according to the order in which it is entered into the global pool 327. By preventing particular queues from including a quantity of commands in excess of a threshold value, the system can preserve resources that would otherwise be incurred due to an even larger quantity of commands being included in the respective queue.

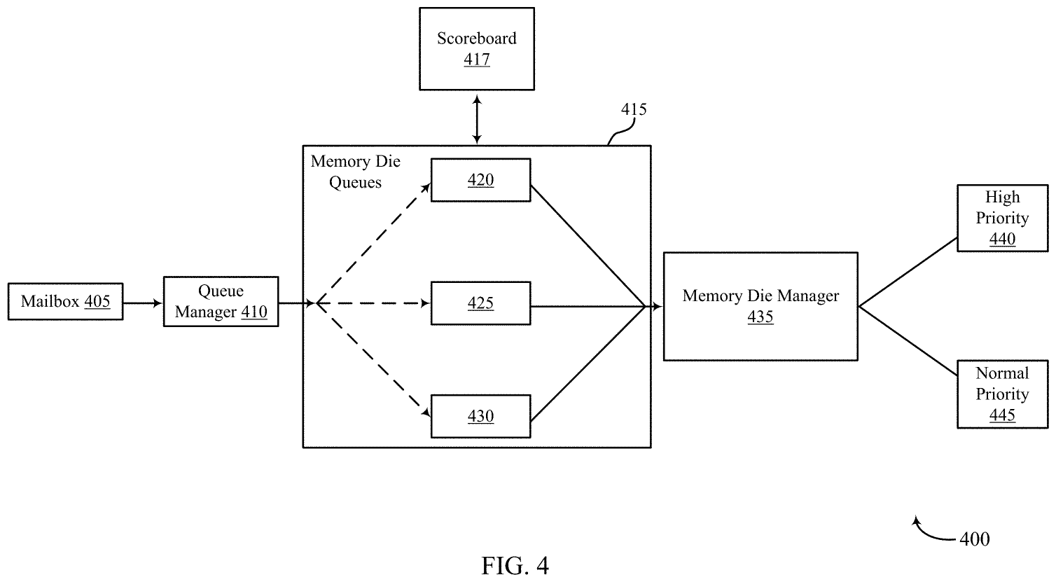

FIG. 4 illustrates an example of a memory sub-system 400 for maintaining queues in accordance with some examples of the present disclosure. The memory sub-system 400 can include a mailbox 405 that includes one or more commands to be transmitted to memory dies of the memory sub-system. The commands may be communicated (e.g., transmitted, sent) to respective memory die queues 415 using the queue manager 410. Each memory die queue 415 can include one or more priority queues, such as priority queues 420, 425, and 430, which can correspond to a first priority queue, a second priority queue, and a third priority queue respectively, as discussed with reference to FIG. 3A. In order to determine a quantity of commands associated with each queue, a scoreboard 417 can keep track (e.g., the scoreboard can maintain a count) a number of commands of each priority queue of each memory die queue 415 of the memory sub-system 400. The memory die manager 435 can issue commands associated with each respective priority queue, and can indicate the commands as high priority 440 or normal priority 445 (or other priority level). Commands indicated as either high priority 440 or normal priority 445 can be issued by a local memory controller.

The mailbox 405 can hold a set of commands to be transmitted to various memory die queues 415 of the memory sub-system. For example, as the commands are received (e.g., from a host device), the commands may be stored (e.g., temporarily stored) in the mailbox 405. The queue manager 410 can assign the commands in the mailbox 405 to a respective memory die queue 415 and, in some examples, to a particular priority queue of the respective memory die queue 415 based on a priority associated with the command. For example, a high priority command can be assigned to the priority queue 420, an intermediate priority command can be assigned to the priority queue 425, and other commands can be assigned to the priority queue 430 (or other priority queues).

In some examples, the queue manager 410 can communicate with the scoreboard 417 and/or the memory die manager 435 to prohibit commands from being assigned to various priority queues and/or memory dies. For example, when a priority queue is mucked, the queue manager 410 may not transmit a command to that queue until the quantity of commands in the queue falls below a threshold value. Additionally, when an entire die is mucked (e.g., due to a number of active memory dies exceeding a threshold value), the queue manager 410 may refrain from transmitting a command to one or more active memory dies until the quantity of active memory dies falls below a threshold value. The number of active memory dies and/or the number of commands included in each priority queue of the memory sub-system can be managed by the scoreboard 417.

The memory die manager 435 can issue commands included in various priority queues of the memory sub-system 400. As discussed herein, commands can be issued based on their respective priority and/or based on the quantity of commands in any one priority queue exceeding a threshold value. Additionally or alternatively, commands associated with a single memory die can be issued based on an active quantity of memory dies exceeding a threshold value. When one or more commands are to be issued, the memory die manager 435 can determine a type of the command (e.g., a read command, a write command, a host read command, a host write command, etc.) and can determine the particular memory cell(s) associate with the command. That is, the memory die manager 435 can associate the command with the resources (e.g., an address of associated memory cells) to issue and perform the command. In some examples, the memory die manager 435 can designate any command(s) as high priority 440 or normal priority 445.

A high priority command 440 can include any command that is to be issued (e.g., issued immediately) based on its priority level and/or a threshold value being exceeded. For example, if a command is received an entered into the first priority queue 420 while commands are being issued from the intermediate priority queue 425, the memory die manager 435 can designate the newly-received command as a high priority 440 command. Accordingly, a local memory controller can issue the command before issuing any other, lower-priority commands (which can be designated normal priority 445). Similarly, if a threshold value of active memory dies and/or a threshold value of commands in a priority queue is exceeded, the memory die manager 435 can any associated commands as high priority 440 commands. Accordingly, a local memory controller can issue the commands before issuing any other, lower-priority commands (which can be designated normal priority 445). Issuing commands in such a manner can allow the system to preserve resources that would otherwise be incurred due to an even larger quantity of commands being included in a respective queue or in a large quantity of memory dies.

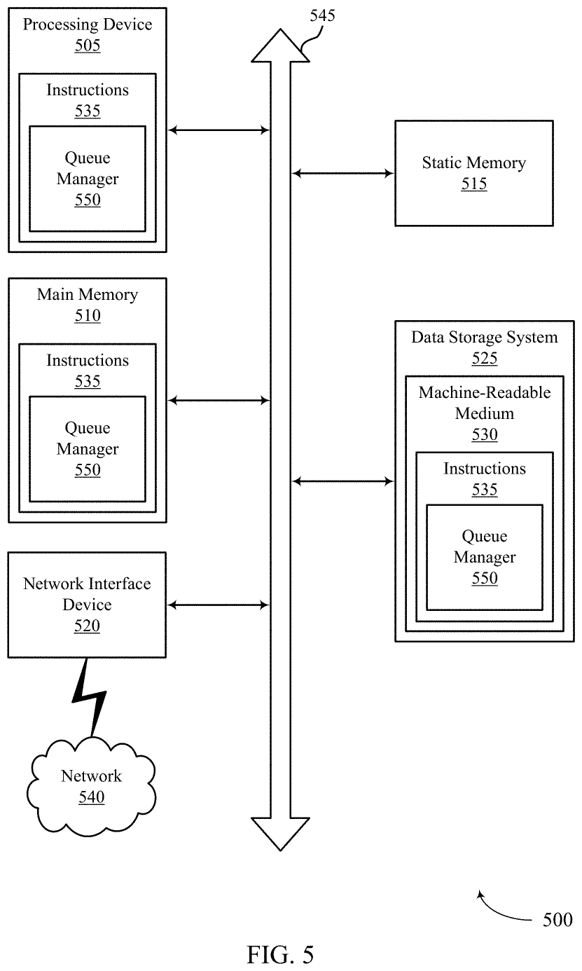

FIG. 5 illustrates an example machine of a computer system 500 that supports maintaining queues for memory sub-systems in accordance with examples as disclosed herein. The computer system 500 can include a set of instructions, for causing the machine to perform any one or more of the techniques described herein. In some examples, the computer system 500 can correspond to a host system (e.g., the host system 105 described with reference to FIG. 1) that includes, is coupled with, or utilizes a memory sub-system (e.g., the memory sub-system 110 described with reference to FIG. 1) or can be used to perform the operations of a controller (e.g., to execute an operating system to perform operations corresponding to the queue manager 150 described with reference to FIG. 1). In some examples, the machine can be connected (e.g., networked) with other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” can also include any collection of machines that individually or jointly execute a set (or multiple sets) of instructions to perform any one or more of the methodologies discussed herein.

The example computer system 500 can include a processing device 505, a main memory 510 (e.g., ROM, flash memory, DRAM such as SDRAM or Rambus DRAM (RDRAM), etc.), a static memory 515 (e.g., flash memory, static RAM (SRAM), etc.), and a data storage system 525, which communicate with each other via a bus 545.

Processing device 505 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 505 can also be one or more special-purpose processing devices such as an ASIC, an FPGA, a DSP, network processor, or the like. The processing device 505 is configured to execute instructions 535 for performing the operations and steps discussed herein. The computer system 500 can further include a network interface device 520 to communicate over the network 540.

The data storage system 525 can include a machine-readable storage medium 530 (also known as a computer-readable medium) on which is stored one or more sets of instructions 535 or software embodying any one or more of the methodologies or functions described herein. The instructions 535 can also reside, completely or at least partially, within the main memory 510 and/or within the processing device 505 during execution thereof by the computer system 500, the main memory 510 and the processing device 505 also constituting machine-readable storage media. The machine-readable storage medium 530, data storage system 525, and/or main memory 510 can correspond to a memory sub-system.

In one example, the instructions 535 include instructions to implement functionality corresponding to a queue manager 550 (e.g., the queue manager 150 described with reference to FIG. 1). While the machine-readable storage medium 530 is shown as a single medium, the term “machine-readable storage medium” can include a single medium or multiple media that store the one or more sets of instructions. The term “machine-readable storage medium” can also include any medium that is capable of storing or encoding a set of instructions for execution by the machine and that cause the machine to perform any one or more of the methodologies of the present disclosure. The term “machine-readable storage medium” can include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as ROM, RAM, magnetic disk storage media, optical storage media, flash memory components, etc.

In the foregoing specification, examples of the disclosure have been described with reference to specific example examples thereof. It will be evident that various modifications can be made thereto without departing from the broader spirit and scope of examples of the disclosure as set forth in the following claims. The specification and drawings are, accordingly, to be regarded in an illustrative sense rather than a restrictive sense.

What is claimed is:

1. A method, comprising:
determining a number of commands included in a queue of a plurality of queues of a memory die of a memory sub-system, each command being associated with a respective operation to be performed on the memory sub-system, wherein each queue of the plurality of queues is associated with a respective priority level and is configured to maintain a respective set of commands to be performed on the memory sub-system;
assigning a command to the queue of the plurality of queues based at least in part on the number of commands that are included in the queue; and
issuing one or more commands from the respective sets of commands of the plurality of queues based at least in part on the respective priority levels.

2. The method of claim 1, further comprising:
prohibiting each of the plurality of queues that have a number of commands that exceeds a threshold value from accepting additional commands until the number of commands is below the threshold value.

3. The method of claim 2, further comprising:
assigning one or more additional commands to each queue having a respective number of commands below the threshold value; and
issuing the one or more additional commands from each queue based at least in part on the respective priority levels.

4. The method of claim 3, further comprising:
issuing all of the commands for each queue having the number of commands that exceed the threshold value, wherein assigning one or more additional commands to each queue is based at least in part on issuing all of the commands.

5. The method of claim 2, further comprising:
storing, to a memory of the memory sub-system, at least one command associated with a queue having a respective number of commands that exceeds the threshold value; and
assigning the command to the queue based at least in part on the respective number of commands falling below the threshold value.

6. The method of claim 2, wherein the threshold value is based at least in part on resources of the memory sub-system available for performing operations on the memory sub-system.

7. The method of claim 1, further comprising:
assigning, to a set of queues for a plurality of memory dies of the memory sub-system, one or more commands associated with operations to be performed on the memory sub-system, wherein each queue of the set of queues is associated with a respective priority level; and
issuing commands from the set of queues according to the respective priority levels.

8. The method of claim 7, further comprising:
determining a number of active memory dies of the memory sub-system; and
prohibiting one or more active memory dies of the memory sub-system from accepting additional commands when the number of active memory dies exceeds a threshold value.

9. The method of claim 8, further comprising:
determining that a plurality of active memory dies of the memory sub-system exceed the threshold value, wherein prohibiting the one or more active memory dies from accepting additional commands is based at least in part on a number of commands associated with each of the one or more active memory dies.

10. The method of claim 1, wherein the one or more commands for performing an operation on the memory die includes a read command, a write command, a host read command, a host write command, or a combination thereof.

11. A system comprising:
a plurality of memory components; and
a processing device, operatively coupled with the plurality of memory components, to:
determine a number of commands that are included in one of a plurality of queues of a memory die of a memory sub-system, the commands being associated with a respective operation to be performed on the memory sub-system, wherein each queue of the plurality of queues is associated with a respective priority level and is configured to maintain a respective set of commands to be performed on the memory sub-system;
assign a command to the queue based at least in part on the number of commands that are included in the queue; and
transmit, to one or more of the plurality of memory components, one or more commands from the respective sets of commands of the plurality of queues based at least in part on the respective priority levels.

12. The system of claim 11, further comprising:
the processing device further to:
prohibit each of the plurality of queues having a number of commands that exceeds a threshold value from accepting additional commands until the number of commands satisfies the threshold value.

13. The system of claim 12, further comprising:
the processing device further to:
assign one or more additional commands to each queue that includes a number of commands that does not exceed the threshold value; and
transmit the one or more additional commands from the respective queues based at least in part on the respective priority levels.

14. The system of claim 13, further comprising:
the processing device further to:
transmit all of the commands associated with each queue having the number of commands that exceeded the threshold value, wherein adding one or more additional commands at each queue that included the number of commands that exceed the threshold value is based at least in part on issuing all of the commands.

15. The system of claim 12, further comprising:
the processing device further to:
store, to a memory component, at least one command associated with a queue that includes the number of commands that exceeds the threshold value; and
assign the command to the queue based at least in part on the number of commands of the respective queue falling below the threshold value.

16. A non-transitory computer-readable storage medium comprising instructions that, when executed by a processing device, cause the processing device to:
determine a number of commands included in a queue of a plurality of queues of a memory die of a memory sub-system, each command being associated with a respective operation to be performed on the memory sub-system, wherein each queue of the plurality of queues is associated with a respective priority level and is configured to maintain a respective set of commands to be performed on the memory sub-system;
assign a command to the queue of the plurality of queues based at least in part on the number of commands that are included in the queue; and
issue one or more commands from the respective sets of commands of the plurality of queues based at least in part on the respective priority levels.

17. The non-transitory computer-readable storage medium of claim 16, wherein the processing device is further to:
prohibit each of the plurality of queues that have a number of commands that exceeds a threshold value from accepting additional commands until the number of commands is below the threshold value.

18. The non-transitory computer-readable storage medium of claim 17, wherein the processing device is further to:
assign one or more additional commands to each queue having a respective number of commands below the threshold value; and
issue the one or more additional commands from each queue based at least in part on the respective priority levels.

19. The non-transitory computer-readable storage medium of claim 18, wherein the processing device is further to:
issue all of the commands for each queue having the number of commands that exceed the threshold value, wherein assigning one or more additional commands to each queue is based at least in part on issuing all of the commands.

20. The non-transitory computer-readable storage medium of claim 17, wherein the processing device is further to:
store, to a memory of the memory sub-system, at least one command associated with a queue having a respective number of commands that exceeds the threshold value; and
assign the command to the queue based at least in part on the respective number of commands falling below the threshold value.
